(19) United States
(12) Patent Application Publication
(10) Pub. No.: US 2002/0073215 A1
(43) Pub. Date: Jun. 13, 2002

(54) Method and system for transmitting encapsulated IPV6 data packets

(76) Inventors: Christian Huitema, Clyde Hill, WA (US); David J. Marples, Mansfield (GB)

Correspondence Address: Joseph Giordano, Esq., Telcordia Technologies, Inc., Room No. 1G112R, 445 South Street,, Morristown,, NJ, 07960, US

(21) Appl. No.: 09/732,068

(22) Filed: Dec. 7, 2000

(51) Int. Cl. G06F 15/16

(52) U.S. Cl. 709/230; 709/246; 709/249

(57) ABSTRACT

A method and system for filtering data packet traffic, e.g., Internet traffic, includes the steps of: (1) receiving a data packet from the data packet traffic; (2) determining whether the data packet from the data packet traffic includes data associated with a first protocol, e.g., IPv6, encapsulated within data associated with a second protocol, e.g., IPv4; (3) removing data associated with the second protocol from the data packet if the data packet includes data associated with the first protocol encapsulated within data associated with the second protocol; and (4) transmitting the data packet including data associated with only the first protocol or the second protocol. The method and system also operate in a reverse direction, i.e., for encapsulating data packets of a first protocol within data associated with a second protocol.

### FIELD OF INVENTION

The present invention relates to communications systems in general and more particularly to a method and system in which encapsulated IPv6 data packets are transmitted as part of IPv4 data packets.

### BACKGROUND

The continuing increase in Internet use over the past decade has required that Internet hardware and software engineers reconsider the capacity and scalability of the existing Internet Protocol (IP) transport. IP version 4 (“IPv4”) is presently the dominant Internet protocol used for Internet communications. While IPv4 has thus far proven sufficiently resilient and adaptable to handle the Internet's rapid growth, the scalability of IPv4's 32 bit addressing scheme is approaching its limit.

IP version 6 (“IPv6”) is designed to address the shortcomings of IPv4. As is known in the art, by using a 128 bit addressing scheme, IPv6 provides a greater number of addresses than IPv4, thus allowing a greater number of IP devices to be connected to the Internet. IPv6 also adds many improvements to IPv4 in areas such as routing and network auto configuration. Accordingly, IPv6 is expected to gradually replace IPv4 over the next several years.

In the meantime, however, IPv4 and IPv6 will coexist. Accordingly, methods and systems have been introduced that allow IPv6 data packets to be encapsulated within IPv4 data packets. The encapsulating of IPv6 data packets into IPv4 data packets is known in the art as IPv6 tunneling. RFC 1933, (Network Working Group Request for Comment: 1933, R. Gilligan, E. Nordmark, Sun Microsystems Inc. April 1996, (ftp://ftp.ipv6.org/pub/rfc/rfc 1993.txt) which is hereby incorporated by reference herein in its entirety describes a method of IPv6 tunneling wherein IPv6 enabled routers and nodes handle both IPv4 and IPv6 traffic. In this way, features of IPv6 may be realized within the constraints of existing IPv4 hardware and software infrastructure.

With reference to FIG. 1, a logical representation of an IPv6 data packet 90 encapsulated within an IPv4 data packet 100 is illustrated. As is shown, IPv4 data packet 100 includes known IPv4 header information 110 necessary for routing an IPv4 packet through IPv4 nodes and routers. The first four bits 120 of the IPv4 header information 110 identify the IP version of data packet 90, in this case, version 4. Pursuant to RFC 1933, the IPv4 data packet is identified as containing IPv6 data packet 90.

With continued reference to FIG. 1, it is seen that in accordance with the method known in the art, IPv6 data packet 90 is encapsulated in IPv4 data packet 100 immediately after IPv4 header information 110. IPv6 data packet 90 includes IPv6 header information 150 followed by IPv6 data payload 160. As is shown, the first four bits 155 of IPv6 header information 150 identify the IP version of the data packet, in this case, version 6.

With further reference to IPv4 data packet 100, it is seen that IPv4 data packet 1100 may also include OSI Layer 4-7 header information 170.

FIG. 2 illustrates a known system for delivering an IPv6 data packet encapsulated within an IPv4 data packet, i.e., an encapsulated IPv6 packet, to an IPv6 enabled device. An IPv6 enabled terminal device 200 delivers a pure IPv6 data packet destined for one of IPv6 devices 250 and 260 to a router 210 which encapsulates the pure IPv6 packet in an IPv4 packet data.

The encapsulated IPv6 packet is then tunneled through the IPv4 network to a tunnel endpoint, i.e. IPv4/IPv6 de-packetizer 230, which removes the IPv4 encapsulation from the IPv6 data packet and delivers it to local IPv6 network 240. As is known in the art, tunnel endpoint 230 requires a valid unique IPv4 address.

With continued reference to FIG. 2, destination 220 may be a home or office and contains IPv6 enabled devices 250 and 260. IPv6 enabled devices 250 and 260 each contain an IPv6 stack which is known in the art and which allows an IP device to operate using IPv6 data packets.

As is shown in FIG. 2, the encapsulated IPv6 data packet arrives at a communications modem 265 and is delivered to IPv6 tunnel endpoint, 230, having the IPv4 address that is in the header of the encapsulated IPv6 data packet.

Thus, it is seen that one of the benefits of IPv6, i.e., increased addressing space, is not realized because a unique IPv4 address is still required for the tunnel endpoint 230.

What is desired therefore is a method and system that allow IPv6 devices to be deployed in existing environments where only a single IPv4 address is available. What is further desired is a method and system that does not require an lPv6 device to have the capability to read IPv4 data packets.

### SUMMARY

The present invention is a method for filtering data packet traffic, e.g., Internet traffic, including the steps of: (1) receiving a data packet from the data packet traffic; (2) determining whether the data packet from the data packet traffic includes data associated with a first protocol, e.g., IPv6, encapsulated within data associated with a second protocol, e.g., IPv4; (3) removing data associated with the second protocol from the data packet if the data packet includes data associated with the first protocol encapsulated within data associated with the second protocol; and (4) transmitting the data packet including data associated with only the first protocol or the second protocol as part of the data packet traffic. The method also operates in a reverse direction, i.e., for encapsulating data packets of a first protocol within data associated with a second protocol.

Also described herein is a system implementing the above-described method for filtering data packet traffic including: (1) one or more input ports for receiving data packet traffic; (2) one or more output port for transmitting data packet traffic; (3) electronic memory; and (4) a logic device. The system is preferably a stand-alone device disposed between the Internet and an end-user device.

The present invention provides a system and method that accepts both IPv4 data packets having IPv6 data packets encapsulated therein, i.e., encapsulated IPv6 data packets, and IPv4 data packets having no IPv6 data packets therein, and thereafter directs the data packets to their respective IPv4 and IPv6 devices. The system and method preferably include an in-line IPv4/IPv6 filter device connected between an Internet access communications modem, e.g., an xDSL modem, and one or more IPv4 and/or IPv6 devices. The in-line filter device intercepts all incoming IPv4 packets from the modem and outputs respective IPv4 and IPv6 data packets to their respective IP device. The in-line filter device effectively separates the encapsulated IPv6 traffic into its respective IPv4 and IPv6 protocols.

### DESCRIPTION OF THE DRAWINGS

Other objects and features of the present invention will be described hereinafter in detail by way of certain preferred embodiments with reference to the accompanying drawings, in which:

FIG. 1 is an illustration of a conventional header of an IPv6 data packet encapsulated within an IPv4 data packet;

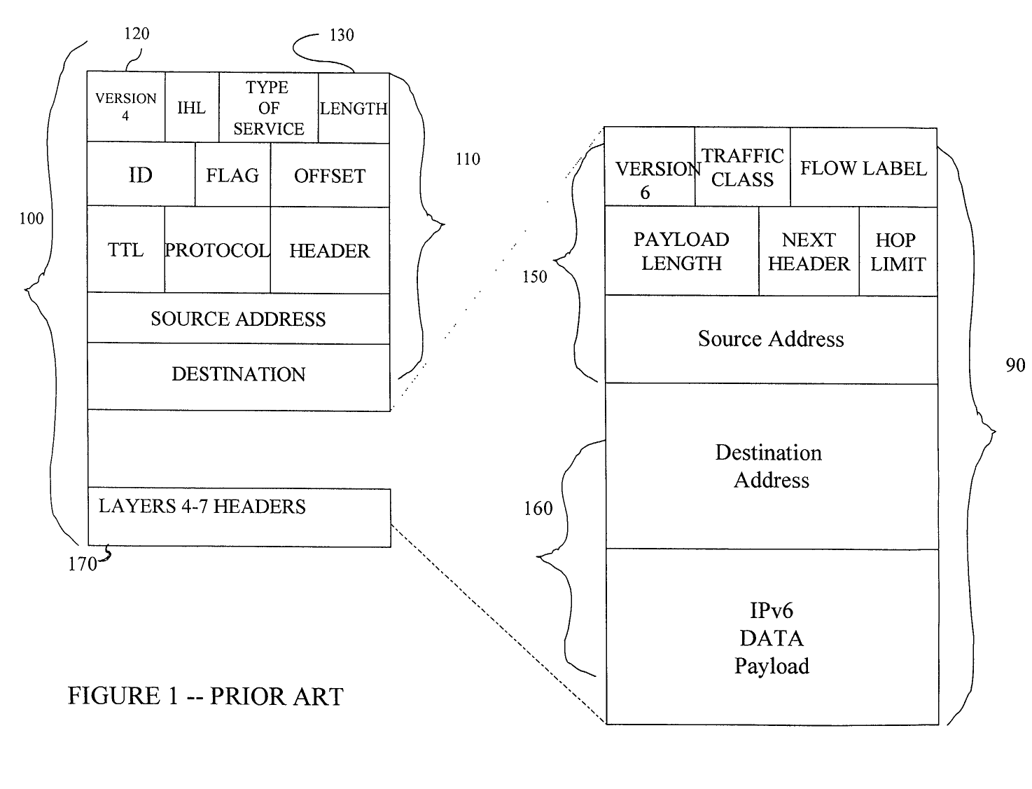

FIG. 2 is a block diagram of a conventional system for delivering an IPv6 data packet encapsulated within an IPv4 data packet;

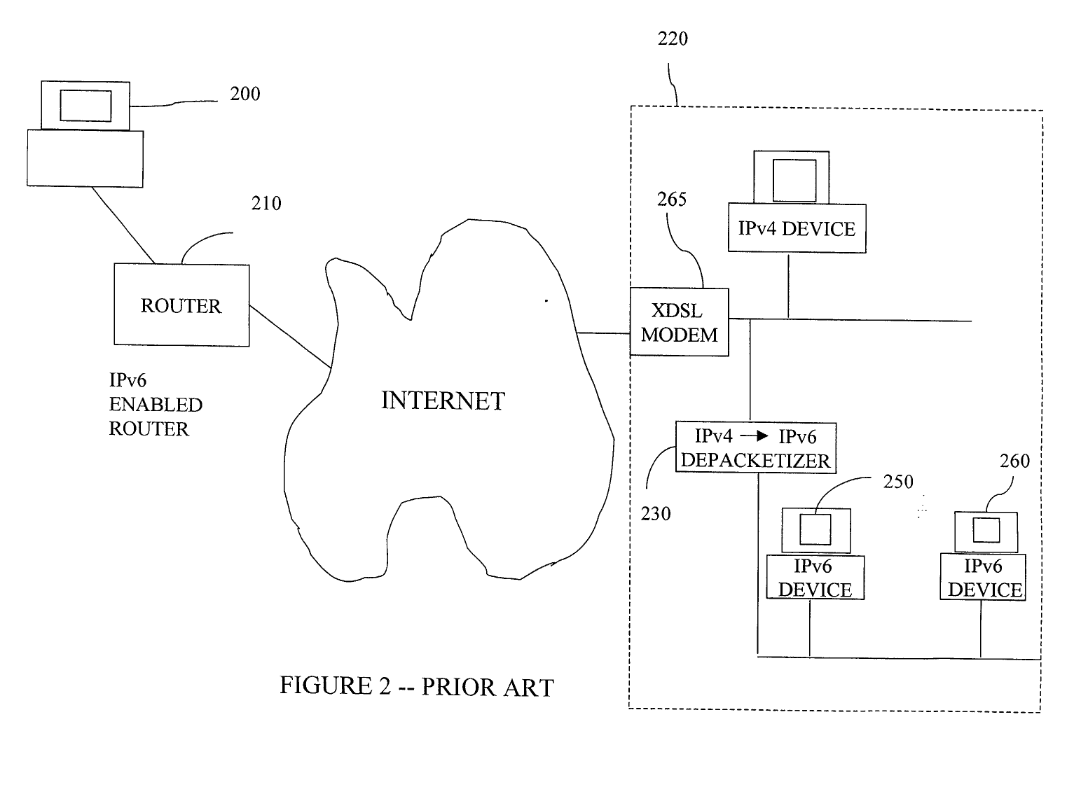

FIG. 3 is a block diagram of an illustrative embodiment of the invention utilizing an IPv4/lPv6 filter device;

FIG. 4 is a block diagram of a flow chart of the filtering and forwarding procedure of the present invention; and

FIG. 5 is a block diagram of an illustrative embodiment of an IPv4/lPv6 filter device of the present invention.

### DETAILED DESCRIPTION

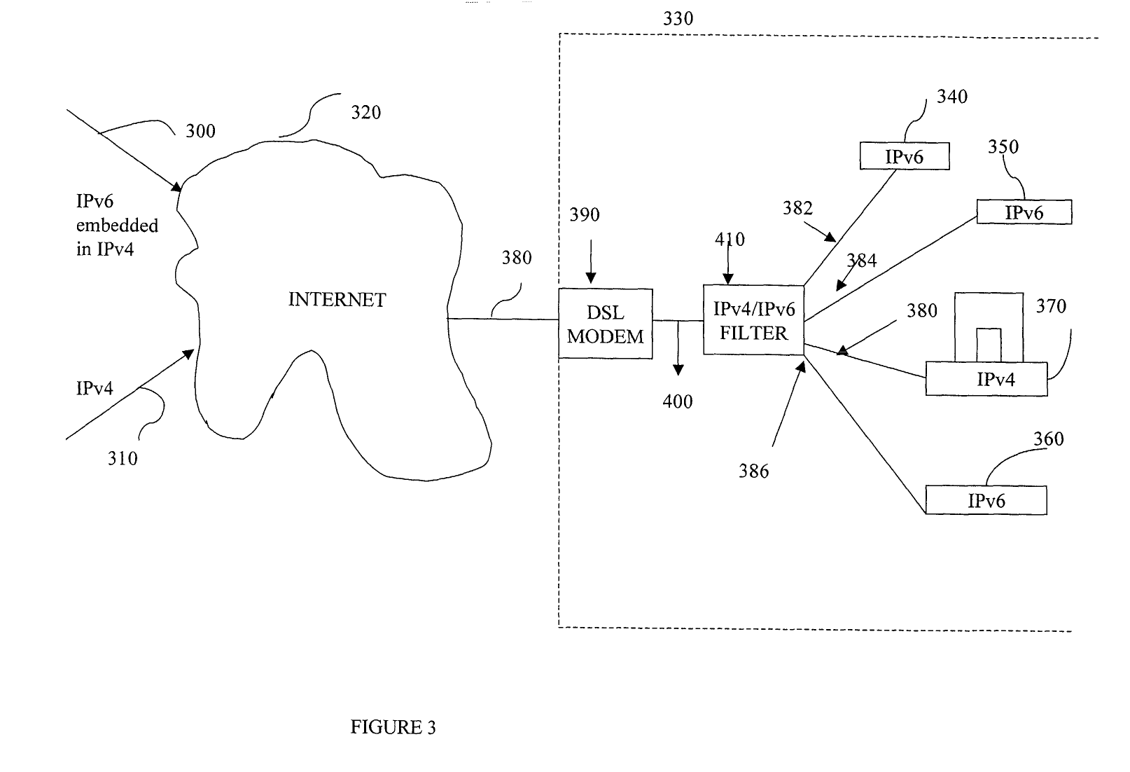

FIG. 3 illustrates an illustrative embodiment of the invention utilizing the above-described IPv4/IPv6 filter device. As is shown, encapsulated IPv6 data packet traffic 300 and IPv4 data packet traffic 310 (having no IPv6 traffic encapsulated therein) are directed through the Internet 320 to a remote home or office site 330 having multiple IPv6 devices 340, 350 and 360 and a single IPv4 device 370. The encapsulated IPv6 data packet traffic 300 and the IPv4 traffic 310 share a common IPv4 destination address, i.e., the address of IPv4 device 370. IPv6 devices 340, 350 and 360 each have a unique IPv6 address.

With continued reference to FIG. 3, encapsulated IPv6 data packet traffic 300 and IPv4 data packet traffic 310 are delivered via an Internet connection 380 to communications modem 390. It is understood that although communications modem 390 is represented as a DSL modem in FIG. 3, communications modem 390 can be any modem or communications device capable of signal conversion between the OSI Layer 1 physical parameters of modem input connection 380, e.g., analog discrete multi-tone signals, and the OSI Layer 1 physical parameters of modem output connection 400, e.g., Manchester NRZ digital signals.

Communications modem 390 delivers, via connection 400, encapsulated IPv6 data packet traffic and IPv4 data packet traffic to IPv4/IPv6 filter device 410. IPv4/IPv6 filter device 410 accepts encapsulated IPv6 data packets and IPv4 data packets and, for each packet received, determines whether an IPV6 packet is encapsulated within the IPv4 packet. If there is an encapsulated IPv6 data packet in the IPv4 data packet being read, the IPv4 header information and all other data relating to the IPv4 packet are stripped away by IPv4/IPv6 filter device 410 and the remaining IPv6 data packet is delivered to the respective IPv6 device.

Alternately, if IPv4/IPv6 filter device 410 determines that the IPv4 data packet does not have an IPv6 data packet encapsulated therein, the IPv4 data packet is passed through IPv4/IPv6 filter device 410 and delivered to IPv4 device 370.

It is understood that IPv4 device 370 is presented only for purposes of illustration. One skilled in the art will realize that IPv4 destination device 370 is not necessary for the present system and method to operate as described above. IPv6 devices 340, 350 and 360 may share a common IPv4 address regardless of whether IPv4 device 370 is present.

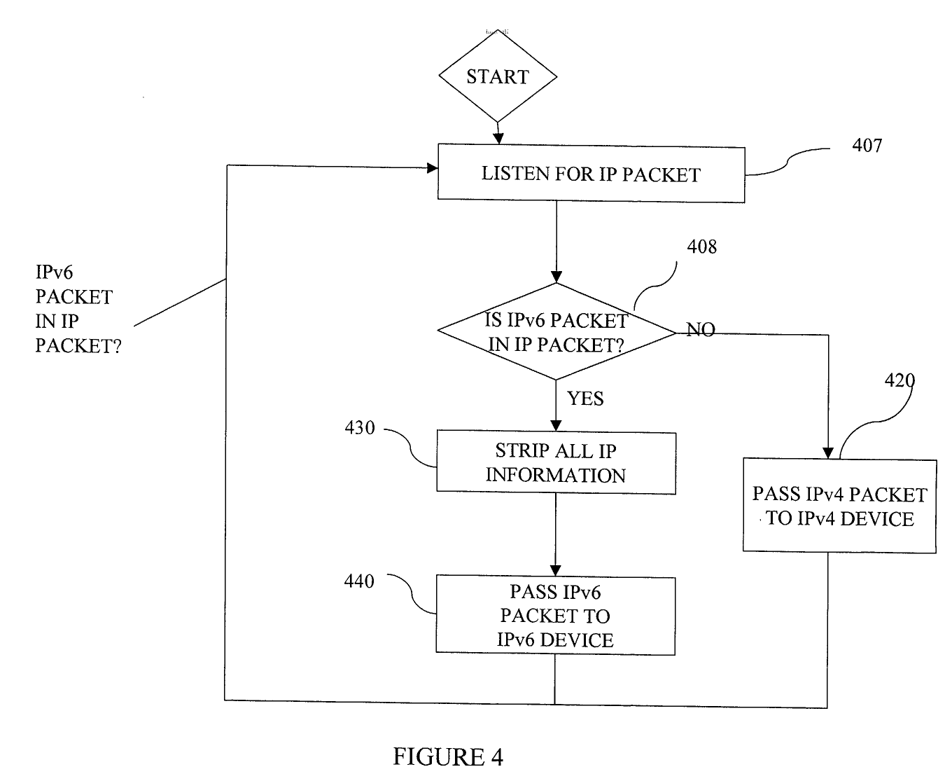

FIG. 4 illustrates a flow chart of the filtering and forwarding procedure followed by lPv4/IPv6 filter device 410.

At step 407, the system checks for IPv4 packets being delivered by communications modem 390 on communications line 405 using methods known in the art. When an IPv4 packet is received, the system proceeds to step 408 and reads the protocol frame of the IPv4 header to determine whether an IPv6 data packet is encapsulated in the IPv4 data packet.

If, at step 408, the system determines that the IPv4 packet does not have an IPv6 data packet encapsulated therein, the system then proceeds to step 420 and passes the IPv4 data packet to IPv4 device 370 through a dataport 380 connecting IPv4/IPv6 filter device 410 as shown in step 420, FIG. 3, and returns to step 407.

Alternately, if at step 408, the system determines that the IPv4 data packet does contain an IPv6 data packet encapsulated therein, the system then proceeds to step 430 and strips the IPv4 data packet of its IPv4 header and other IPv4 related information leaving only the formerly encapsulated IPv6 packet. At step 440, the system thereafter delivers the IPv6 packet to its respective IPv6 device (340, 350 or 360) through a data port (382, 384 or 386) connecting IPv4/IPv6 filter device 410 to a respective IPv6 device as shown in FIG. 3, and returns to step 407.

IPv4/lPv6 filter device 410 operates in a similar manner in the reverse direction. In other words, IPv4 data device 410 accepts IPv4 data packets from IPv4 device 370 and IPv6 data packets from IPv6 devices 340, 350 and 360 and delivers encapsulated IPv6 data packets and IPv4 data packets to communications modem 390 for transport to the Internet 330. When IPv4/IPv6 filter device 410 receives a data packet from one of IP devices 340, 350, 360 and 370, IPv4/IPv6 filter device 410 reads the first four bits in the header of the packet to determine whether the data packet is an IPv4 or IPv6 data packet. If the data packet is an IPv4 data packet, IPV4/IPv6 filter device 410 acts as a pass-through device, i.e., it passes the IPv4 data packet to communications modem 390 without manipulating the data packet. However, if the data packet received is an IPv6 data packet, IPv4/IPv6 filter device 410 encapsulates the IPv6 data packet in an IPv4 data packet. The IPv4 destination address for an IPv6 data packet may be assigned, e.g., as a config-time option. IPv4/IPv6 filter device 410 then passes the encapsulated IPv6 data packet to communications modem 390.

As described above, the present method and system allow multiple IPv6 devices to receive and send IPv6 encapsulated data packets using a single IPv4 address. Furthermore, using the present method and system, an IPv6 enabled device (340, 350 and 360) need not include an IPv4/IPv6 stack or any other hardware or software that reads and manipulates IPv4 data packets.

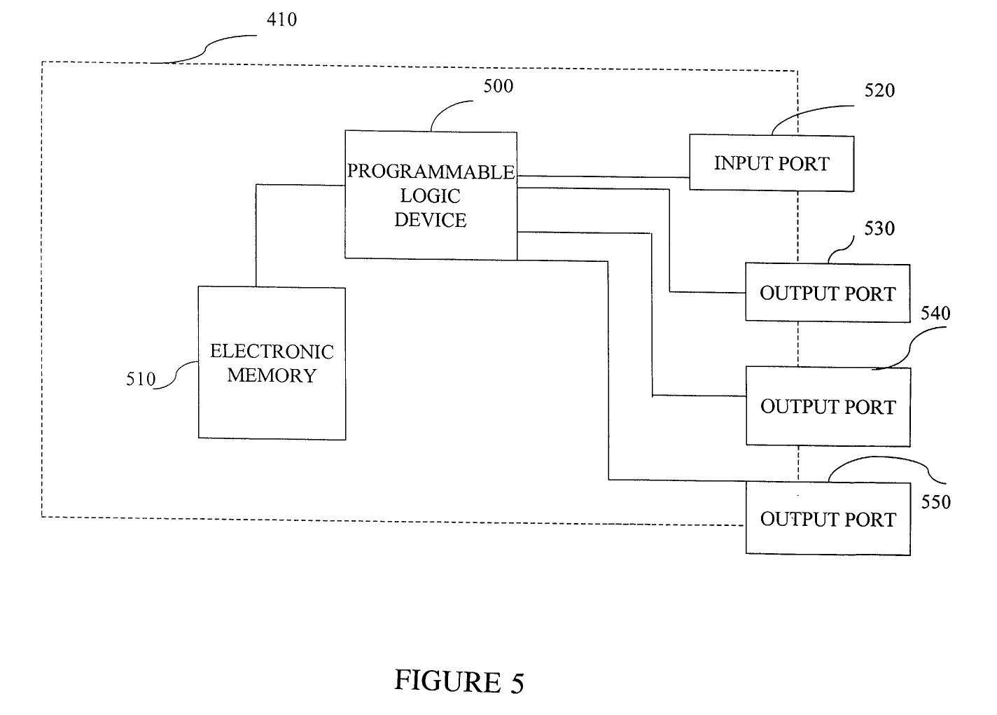

IPv4/IPv6 filter device 410 is constructed using methods and devices known in the art. FIG. 5 illustrates an illustrative embodiment in logic block diagram form of IPv4/IPv6 filter device 410. IPv4/IPv6 filter device 410 may include an embedded microprocessor, DSP, ASIC or any other programmable logic device 500 as well as static and/or dynamic electronic memory 510 connected to programmable logic device 500 for storing and executing the process described by the flowchart of FIG. 4. IPv4/IPv6 filter device 410 is preferably a stand-alone device having appropriately configured input and output ports (520, 530, 540 and 550), e.g., RJ11, RJ-45 and/or serial pin cable connectors, providing an input connection from communications modem 390 and one or more output connections to IP devices 340, 350, 360 and 370. In the preferred embodiment, the input and output ports (520, 530, 540 and 550) are bi-directional, allowing any port to send or receive data.

Variations of IPv4/Pv6 filter device 410 may be realized. IPv4/IPv6 filter device 410 may have only one output which connects, e.g., to a broadcast device such as an Ethernet hub. In this way all of the IP data packets output by IPv4/IPv6 filter device 410, whether IPv4 or IPv6, are broadcast to all of IP devices 340, 350, 360 and 370. Each device may then determine, based on the version field of the IPv4 or IPv6 header respectively, whether that packet is directed to that particular type of device, i.e., to an IPv4 or an IPv6 device.

Further variations of the above-described method and system may be realized and are within the scope of the present invention. For example, the functionality of IPv4/IPv6 filter device 410 may be included with other network devices, e.g., an OSI Layer 1 device such as an xDSL modem 390 or an OSI Layer 2 device such as an Ethernet bridge or an end-user device such as the protocol stack or network card of a personal computer. In this way IPv4 /IPv6 filtering can be accomplished without the need for a separate physical device.

Additional features may be realized in the process described by FIG. 4. The system, upon detecting an IP packet at step 405 may read the version field of the header and determine whether the data packet received is a non-encapsulated IPv6 data packet, i.e., a pure IPv6 data packet. Thus, IPv4/IPv6 filter device 410 would be useful for filtering Internet traffic having IPv4, embedded IPv6 and pure IPv6 data packets. Similarly, in the reverse or encapsulating direction, IPv4/IPv6 filter device, upon receiving a pure IPv6 data packet, may pass that packet through to IPv6 routers if IPv4/IPv6 filter device knows such equipment and capability are available.

It is thus apparent to one skilled in the art that many other variations of the present system and method may be realized without departing from the scope of the invention. Furthermore, the present invention is not limited to only filtering encapsulated IPv6 data packets from IPv4 data packets. Rather, the present method and system can be utilized to filter any type of encapsulated data whose format is identifiable in the encapsulating data packet.

What is claimed is:

1. A method for filtering data packet traffic comprising the steps of:
receiving a data packet from the data packet traffic;
determining whether the data packet from the data packet traffic includes data associated with a first protocol encapsulated within data associated with a second protocol;
removing data associated with the second protocol from the data packet if the data packet includes data associated with the first protocol encapsulated within data associated with the second protocol; and
transmitting a data packet including data associated with only the first protocol or the second protocol.

2. The method of claim 1, wherein said data packet traffic includes Internet data.

3. The method of claim 1, wherein the first protocol is IPv6 and the second protocol is IPv4.

4. The method of claim 1, wherein the determining step includes the step of reading data of the second protocol for an indication as to whether the data includes data associated with the first protocol.

5. The method of claim 1 including the additional step of delivering the data packet to an end device associated with the first or second protocol.

6. The method of claim 1, including the additional step of converting between a first and a second set of physical parameters associated with the data packet .

7. The method of claim 7, wherein the first set of physical parameters includes parameter of OSI Layer 1 and the second set of physical parameters includes parameters of OSI Layer 2.

8. A system for filtering data packet traffic comprising:
one or more input ports for receiving data packet traffic;
one or more output ports for transmitting data packet traffic;
electronic memory; and
a logic device connected to the one or more input ports, the one or more output ports and the electronic memory, the logic device being programmed to:
receive a data packet from the data packet traffic;
determine whether the data packet from the data packet traffic includes data associated with a first protocol encapsulated within data associated with a second protocol;
remove data associated with the second protocol from the data packet if the data packet includes data associated with the first protocol encapsulated within data associated with the second protocol; and
transmit a data packet including data associated with only the first protocol or the second protocol.

9. The system of claim 8 wherein the system is disposed between the Internet and a user device operating with the first or second protocol.

10. The system of claim 8, wherein the first protocol is IPv6 and the second protocol is IPv4.

11. The system of claim 8, wherein the system further includes means for converting between a first and a second OSI layer.

12. The system of claim 8, wherein the system is contained in a personal computer.

13. A method for transmitting data packet traffic, said data packet traffic comprising a plurality of data packets associated with an IPv6 protocol, wherein said data packets are encapsulated in data associated with an IPv4 protocol, and wherein a plurality of said data packets associated with said IPv6 protocol has a unique IPv6 address and shared IPv4 address, said method comprising the steps of:
filtering the data packets associated with said IPv6 traffic from the data packet traffic at a location identified by said shared IPv4 address; and
directing each of said IPv6 associated data packets to a destination identified by said IPv6 associated data packets' unique IPv6 address.
